(19) United States
(12) Patent Application Publication
(10) Pub. No.: US 2011/0183250 A1
(43) Pub. Date: Jul. 28, 2011

(54) DEVELOPING AGENT

(75) Inventor: Hisanobu Ajima, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/978,790

(22) Filed: Dec. 27, 2010

Related U.S. Application Data
(60) Provisional application No. 61/299,089, filed on Jan. 28, 2010.

(51) Int. Cl. G03G 9/08

(52) U.S. Cl. 430/108.21; 430/105; 430/108.6; 430/108.7; 430/110.4; 430/108.2; 430/108.4; 430/108.1

(57) ABSTRACT

According to one embodiment, a developing agent includes toner particles containing a coloring agent, a binder resin, and a moisturizing agent, and an additive which is added to the surfaces of the toner particles is provided. The moisturizing agent is added in an amount of from 5 to 20% by weight based on the weight of the toner particles. Further, the developing agent satisfies the following formula (1) C=A×B≧10. In the formula (1), A represents the volume average particle diameter of the toner particles (μm), B represents the addition amount of the additive (% by weight), and C represents a coverage factor.

### CROSS-REFERENCE TO RELATED APPLICATIONS

This application is based upon and claims the benefit of priority from U.S. Provisional Application No. 61/299,089 filed on Jan. 28, 2010, the entire contents of which are incorporated herein by reference.

### FIELD

Embodiments described herein relate generally to a developing agent for use in developing an electrostatic image or a magnetic latent image in an electrophotographic process, an electrostatic printing process, a magnetic recording process, or the like.

### BACKGROUND

Heretofore, a variation in charging characteristic of a two-component toner using a carrier due to an environmental change had a large influence on an image and was a problem to be solved for maintaining an image quality. As measures for reducing the environmental dependence, for example, a method for preventing an increase in charge amount under a low-temperature and low-humidity environment by applying a low-resistance substance such as titanium oxide as an additive to a toner surface, thereby reducing the resistance of the toner surface was-used.

However, when the above toner is applied to an image forming apparatus having a so-called toner recycling system in which a transfer residual toner is recovered by a cleaning device, replenished into a developing device again and reused, the low-resistance substance on the toner surface is preferentially recovered, and a defect in image quality such as fogging was caused, and therefore, the life thereof has to be set to be short.

### DESCRIPTION OF THE DRAWING

The single figure is a view showing an image forming apparatus in which a developing agent according to an embodiment can be used.

### DETAILED DESCRIPTION

In general, according to one embodiment, a developing agent comprising toner particles containing a coloring agent, a binder resin, and a moisturizing agent, and an additive which is added to the surfaces of the toner particles is provided.

According to the embodiment, by incorporating the moisturizing agent, an increase in charge amount under a low-temperature and low-humidity environment can be prevented, and the environmental dependence, particularly humidity dependence can be reduced.

Further, according to the embodiment, deterioration of the storage property due to the moisturizing agent in the developing agent can be prevented by the additive added to the surfaces of the toner particles.

According to this configuration, a favorable image can be formed stably without deteriorating the image quality.

In the embodiment, a coverage factor C can satisfy the following formula (1).

C=A×B≧10 (1)

In the formula (1), A represents the volume average particle diameter of the toner particles (μm), and B represents the addition amount of the additive (% by weight).

As the volume average particle diameter of the toner particles is decreased, the specific surface area thereof is increased, and therefore, the probability that the moisturizing agent is exposed on the surfaces thereof is increased. When the moisturizing agent is added to the toner particles, a harmful effect is caused, for example, the storage stability of the toner is deteriorated or the toner is liable to adhere to a photoconductor. Therefore, according to the embodiment, by increasing the addition amount of the additive to the surfaces of the toner particles, such a harmful effect is reduced. As shown in the above formula, by allowing the numerical value obtained by multiplying the volume average particle diameter of the toner particles by the addition amount of the additive to fall within a range of 10 or more, a developing agent which does not have a harmful effect on image quality can be formed.

According to this configuration, an increase in charge amount under a low-temperature and low-humidity environment can be more favorably prevented without deteriorating the image quality and storage stability of the developing agent.

In the embodiment, the moisturizing agent can be added in an amount of from 5 to 20% by weight based on the weight of the toner particles.

In the embodiment, as the additive, at least one of silicon oxide and titanium oxide can be used.

In the embodiment, the volume average particle diameter of the additive can be set to 16 nm or less, more preferably set to 8 nm to 16 nm.

If the volume average particle diameter of the additive exceeds 16 nm, the volume of covering the toner surface with the same addition amount of the additive tends to decrease. Moreover, if the volume average particle diameter of the additive exceeds 17 nm, the contribution thereof to the control of charge amount tends to decrease, and if it is less than 8 nm, the additive itself becomes an aggregate, and the effect of the additive tends to be substantially the same as in the case where the average particle diameter of the additive is from 8 to 16 nm.

In the embodiment, the coverage factor C can be set to 10 to 50.

If the coverage factor C is less than 10, the area of covering the toner with the additive tends to decrease, and if it exceeds 50, the area of covering the toner with the additive is excessive and the effect of the additive tends to be the same as in the case where the coverage factor C is in the above range.

As the binder resin, a styrene acrylic resin, a polyester resin, or the like can be used.

Examples of a styrene (A) of the styrene acrylic resin include styrene, α-methylstyrene, t-butylstyrene, dimethylstyrene, acetoxystyrene, and vinyl toluene. Further, as (meth)acrylonitrile (B), acrylonitrile or methacrylonitrile is used. Examples of a (meth)acrylic acid ester (C) include methyl (meth)acrylate, butyl (meth)acrylate, nonyl (meth)acrylate, decyl (meth)acrylate, undecyl (meth)acrylate, dodecyl (meth) acrylate, tridecyl (meth) acrylate, tetradecyl (meth) acrylate, pentadecyl (meth) acrylate, hexadecyl (meth)acrylate, octadecyl (meth)acrylate, eicosyl (meth)acrylate, docosyl (meth)acrylate, and hydroxypolyoxyalkylene ether mono(meth)acrylates.

Further, when a polyester resin is used, the polyester resin can be obtained using a monomer containing an acid component such as a carboxylic acid component composed of a divalent or higher polyvalent carboxylic acid compound and an alcohol component composed of a dihydric or higher polyhydric alcohol. Examples of the acid component include fumaric acid, maleic acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, or succinic acid substituted with an alkyl group having 1 to 20 carbon atoms or an alkenyl group having 2 to 20 carbon atoms such as dodecenyl succinic acid or octyl succinic acid, anhydrides thereof, derivatives thereof such as alkyl esters. Examples of the alcohol component include aliphatic polyols such as ethylene glycol, propylene glycol, 1,4-butanediol, 1,3-butanediol, 1,5-pentanediol, 1,6-hexanediol, neopentyl glycol, glycerin, trimethylolethane, trimethylolpropane, and pentaerythritol; alicyclic polyols such as 1,4-cyclohexanediol and 1,4-cyclohexanedimethanol; and an ethylene oxide or propylene oxide adduct of bisphenol A or the like.

Further, the above styrene acrylic resin and polyester resin can be used in combination.

Further, as a wax, a natural wax such as carnauba wax or rice wax or a synthetic wax such as polypropylene or polyethylene can be used.

Further, as the coloring agent, carbon black, a yellow pigment that is ordinarily used in a toner such as P.Y. 180, P.Y. 74, P.Y. 17, P.Y. 185, or P.Y. 93, a magenta pigment that is ordinarily used in a toner such as P.R. 122, P.R. 185, P.R. 57:1, P.R. 31, P.R. 238, P.R. 269, P.R. 146, P.R. 147, P.R. 184, or P.V. 19, or a cyan pigment that is ordinarily used in a toner such as P.B. 15 or P.G. 7 can be used.

Examples of the moisturizing agent include glycerin, propylene glycol, butylene glycol, sorbitol, amino acids, pyrrolidone carboxylic acid, lactic acid, and urea. A natural or synthetic component other than these may be used.

As a charge control agent, for example, an iron complex type, a chromium complex type, a boron complex type, a zinc complex type, or the like can be used. Other than these, one or more charge control agents of different types, for example, a combination of any of the above agents, a charge control regulator (CCR) of resin type and the like can also be used in combination.

Further, as the silicon oxide, silicon oxide that is produced by a firing method and is ordinarily used in a toner or silicon oxide used in a wet process can be used.

Further, examples of a conductive inorganic oxide include those containing a metal such as Ti, Si, Al, St, Fe, Mn, Mg, Zn, or Cu.

Further, for example, as a compound serving as a lubricant for a drum cleaner, a higher fatty acid containing Zn, Ca, Mg, Al, or the like, a resin containing fluorine or the like can be used.

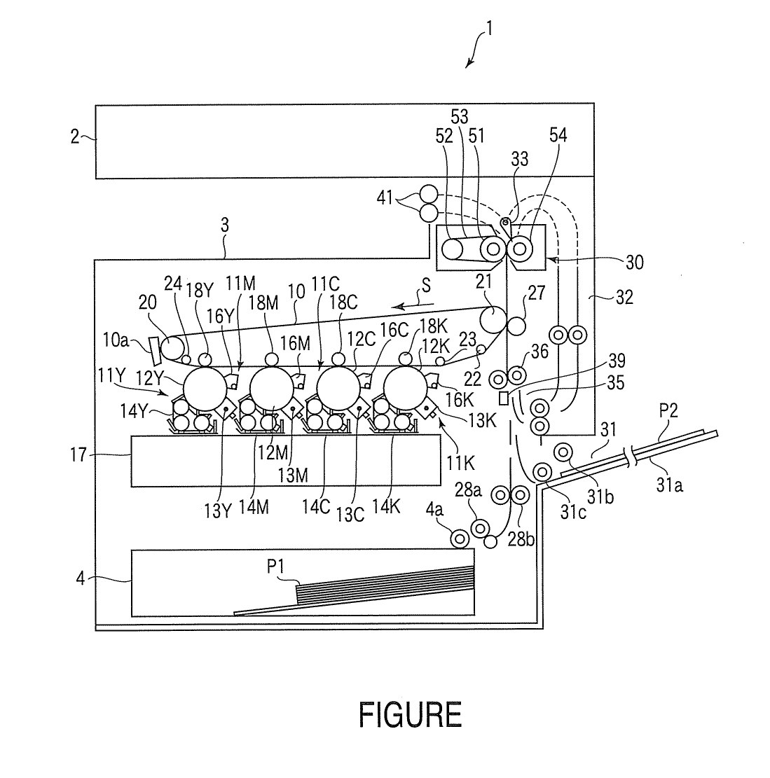

FIG. 1 is a schematic view showing an exemplary image forming apparatus to which a developing agent according to an embodiment can be applied.

As shown in the drawing, a four-drum tandem type color copier MFP (e-studio 4520c) 1 is provided with a scanner unit 2 and a paper discharge unit 3 in the upper part.

The color copier 1 has four sets of image forming stations 11Y, 11M, 11C, and 11K of yellow (Y), magenta (M), cyan (C), and black (K) arranged in parallel along the lower side of an intermediate transfer belt (intermediate transfer medium) 10.

The image forming stations 11Y, 11M, 11C, and 11K have photoconductive drums (image carrying members) 12Y, 12M, 12C, and 12K, respectively. Around the photoconductive drums 12Y, 12M, 12C, and 12K, electric chargers 13Y, 13M, 13C, and 13K, developing devices 14Y, 14M, 14C, and 14K, and photoconductor cleaning devices 16Y, 16M, 16C, and 16K are provided along the rotational direction of the arrow m, respectively. An exposure light from a laser exposure device (latent image forming device) 17 is applied to areas between the respective electric chargers 13Y, 13M, 13C, and 13K and the respective developing devices 14Y, 14M, 14C, and 14K around the photoconductive drums 12Y, 12M, 12C, and 12K, and electrostatic latent images are formed on the photoconductive drums 12Y, 12M, 12C, and 12K, respectively.

The developing devices 14Y, 14M, 14C, and 14K each have a two-component developing agent containing a toner of yellow (Y), magenta (M), cyan (C), or black (K) and a carrier and supply the toner to the electrostatic latent images on the photoconductive drums 12Y, 12M, 12C, and 12K, respectively.

The intermediate transfer belt 10 is tensioned by a backup roller 21, a driven roller 20, and first to third tension rollers 22 to 24. The intermediate transfer belt 10 faces and is in contact with the photoconductive drums 12Y, 12M, 12C, and 12K. At the positions of the intermediate transfer belt 10 facing the photoconductive drums 12Y, 12M, 12C, and 12K, primary transfer rollers 18Y, 18M, 18C, and 18K for primarily transferring toner images on the photoconductive drums 12Y, 12M, 12C, and 12K onto the intermediate transfer belt 10 are provided. The primary transfer rollers 18Y, 18M, 18C, and 18K are each a conductive roller, and apply a primary transfer bias voltage to the respective primary transfer parts.

In a secondary transfer part as a transfer position supported by the backup roller 21 of the intermediate transfer belt 10, a secondary transfer roller 27 is provided. In the secondary transfer part, the backup roller 21 is a conductive roller and a predetermined secondary transfer bias is applied thereto. When a sheet of paper (final transfer medium) which is a print target passes between the intermediate transfer belt 10 and the secondary transfer roller 27, the toner image on the intermediate transfer belt 10 is secondarily transferred onto the paper. After completion of the secondary transfer, the intermediate transfer belt 10 is cleaned by a belt cleaner 10a.

A paper feed cassette 4 for feeding a sheet of paper in the direction toward the secondary transfer roller 27 is provided below the laser exposure device 17. On the right side of the color copier 1, a manual feed mechanism 31 for manually feeding a sheet of paper is provided.

A pickup roller 4a, a separating roller 28a, a conveying roller 28b, and a resist roller pair 36 are provided between the paper feed cassette 4 and the secondary transfer roller 27, and these are constituent members of a paper feed mechanism. A manual feed pickup roller 31b and a manual feed separating roller 31c are provided between a manual feed tray 31a of the manual feed mechanism 31 and the resist roller pair 36.

Further, a medium sensor 39 for detecting the kind of a sheet of paper is disposed on a vertical conveying path 34 for conveying a sheet of paper in the direction from the paper feed cassette 4 or the manual feed tray 31a to the secondary transfer roller 27. In the color copier 1, the conveying speed of a sheet of paper, a transfer condition, a fixing condition, and the like can be controlled according to the detection result of the medium sensor 39. Further, a fixing device 30 is provided in the downstream of the secondary transfer part along the direction of the vertical conveying path 34.

The sheet of paper taken out from the paper feed cassette 4 or fed from the manual feed mechanism 31 is conveyed to the fixing device 30 along the vertical conveying path 34 through the resist roller pair 36 and the secondary transfer roller 27. The fixing device 30 has a set of a heating roller 51 and a driving roller 52, a fixing belt 53 wound around the heating roller 51 and the driving roller 52, and a facing roller 54 disposed to face the heating roller 51 via the fixing belt 53. The sheet of paper having the toner image transferred in the second transfer part is guided between the fixing belt 53 and the facing roller 54 and heated by the heating roller 51, whereby the toner image transferred onto the sheet of paper is fixed through the heat treatment. A gate 33 is provided in the downstream of the fixing device 30, and distributes the sheet of paper in the direction toward a paper discharge roller 41 or the direction toward a re-conveying unit 32. The sheet of paper guided to the paper discharge roller 41 is discharged to the paper discharge unit 3. Further, the sheet of paper guided to the re-conveying unit 32 is again guided in the direction toward the secondary transfer roller 27.

The image forming station 11Y integrally includes the photoconductive drum 12Y and a process system, and is provided such that it is attachable to and detachable from the image forming apparatus main body. The process system refers to at least one of the electric charger 13Y, the developing device 14Y, and the photoconductor cleaning device 16Y. The image forming stations 11M, 11C, and 11K each have the same structure as the image forming station 11Y, and each of the image forming stations 11Y, 11M, 11C, and 11K may be separately attachable to and detachable from the image forming apparatus, or they may be integrally attachable to and detachable from the image forming apparatus as an integral image forming unit 11.

Hereinafter, the developing agent according to the embodiment will be specifically described by showing Examples.

### Examples 1 to 9 and Comparative Examples 1 to 6

In order to prepare a toner, toner particle materials of the following composition were prepared.

### <Composition of Toner Particles>

Moisturizing agent: 5 to 21 parts by weight

Carbon black: 6 parts by weight

CCA T-77: 1.5 parts by weight

Polyethylene wax having a melting point of 99° C.: 5 parts by weight

Styrene acrylic resin (glass transition point: 55.6° C., melt index at 150° C.: 5 g/10 min): 66.5 to 82.5 parts by weight

As the moisturizing agent, sorbitol was used in

Examples 1 to 6, and 8 and 9, an amino acid was used in Example 7. As shown in the following Table 1-1, the addition amounts of the moisturizing agent in Examples 1 to 9 are 5, 10, 15, 20, 5, 15, 15, 20, and 5, respectively, and the addition amounts of the moisturizing agent in Comparative examples 1 to 6 are 21, 15, 4, 5, 15, and 15, respectively.

Further, the styrene acrylic resin was added in an amount such that the total amount of the toner particle composition became 100 parts by weight.

The above toner particle materials were dispersed and mixed using a Henschel mixer, and the resulting mixture was melt-kneaded using a twin-screw extruder, whereby a kneaded material was obtained.

The obtained kneaded material was cooled and then coarsely pulverized using a hammer mill.

Subsequently, the coarsely pulverized material was finely pulverized using a jet mill, and the resulting fine powder was classified using a separator, whereby toner particles were obtained. The obtained toner particles have a volume average particle diameter of from 6.0 to 8.0 μm.

Then, as an additive, silica and/or titanium oxide was mixed with the total weight of the obtained toner particles using a Henschel mixer, whereby a toner was obtained. As shown in Table 1-1, the addition amounts of silica in Examples 1 to 9 were 1, 1, 1, 1, 1.3, 1.2, 1.2, 1.3, and 0 parts by weight, respectively, and the addition amounts of silica in Comparative examples 1 to 6 were 1, 0.8, 1, 1.2, 1.2, and 0 parts by weight, respectively.

Further, as shown in Table 1-1, the addition amounts of titanium oxide in Examples 1 to 9 were 0.3, 0.3, 0.3, 0.3, 0.5, 0.6, 0.6, 0, and 1.7 parts by weight, respectively, and the addition amounts of titanium oxide in Comparative examples 1 to 6 were 0.4, 0.4, 0.3, 0.3, 0.4, and 0 parts by weight, respectively.

The total amount of the additives used is shown in the following Table 1-1.

Further, the coverage factor (C) was calculated for each of the obtained toners from the following equation. The calculated coverage factor (C) is shown in the following Table 1-1.

[volume average particle diameter of toner particles (A)]×[total addition amount of additives (B)]=coverage factor (C)

As shown in Table 1-1, the coverage factors (C) of the toners of Examples 1 to 9 were 10.4, 10.4, 10.4, 10.4, 10.8, 10.8, 10.8, 10.4, and 10.2, respectively, and the coverage factors (C) of the toners of Comparative examples 1 to 6 were 11.2, 9.6, 10.4, 9, 9.6, and 0, respectively.

TABLE 1-1

| | A: Volume | | | | | |
|---|---|---|---|---|---|---|
| | average particle | | | | | |
| | diameter of | Moisturizing | Additive (a) | Additive (b) | Total amount of | |
| | toner particles | agent | silica | titanium oxide | additives | C: coverage |
| | (μm) | (% by weight) | (% by weight) | (% by weight) | (a) + (b) (% by weight) | factor |
| Example 1 | 8 | 5 | 1 | 0.3 | 1.3 | 10.4 |
| Example 2 | 8 | 10 | 1 | 0.3 | 1.3 | 10.4 |
| Example 3 | 8 | 15 | 1 | 0.3 | 1.3 | 10.4 |
| Example 4 | 8 | 20 | 1 | 0.3 | 1.3 | 10.4 |
| Example 5 | 6 | 5 | 1.3 | 0.5 | 1.8 | 10.8 |
| Example 6 | 6 | 15 | 1.2 | 0.6 | 1.8 | 10.8 |
| Example 7 | 6 | 15 | 1.2 | 0.6 | 1.8 | 10.8 |
| Example 8 | 8 | 20 | 1.3 | 0 | 1.3 | 10.4 |
| Example 9 | 6 | 5 | 0 | 1.7 | 1.7 | 10.2 |
| Comparative | 8 | 21 | 1 | 0.4 | 1.4 | 11.2 |
| example 1 | | | | | | |
| Comparative | 8 | 15 | 0.8 | 0.4 | 1.2 | 9.6 |
| example 2 | | | | | | |
| Comparative | 8 | 4 | 1 | 0.3 | 1.3 | 10.4 |
| example 3 | | | | | | |
| Comparative | 6 | 5 | 1.2 | 0.3 | 1.5 | 9 |
| example 4 | | | | | | |
| Comparative | 6 | 15 | 1.2 | 0.4 | 1.6 | 9.6 |
| example 5 | | | | | | |
| Comparative | 6 | 15 | 0 | 0 | 0 | 0 |
| example 6 | | | | | | |

For the thus obtained toners, the measurement and evaluation as follows were carried out.

### Environmental Dependence

A carrier and each of the toners were mixed under a low-temperature and low-humidity environment (LL: 10° C., 20%) and a high-temperature and high-humidity environment (HH, 30° C., 85%), respectively, whereby a developing agent was prepared. The case where a difference in charge amount between LL and HH was less than 5 μc/g was evaluated as good. The charge amount was measured using a suction blow-off powder charge amount measuring device Model TB-220 manufactured by Kyocera Chemical Corporation.

The obtained results are shown in the following Table 1-2.

As shown in Table 1-2, the differences in charge amount between LL and HH when the toners of Examples 1 to 9 were used were 4.4, 3, 2.5, 2, 4, 2, 2.5, 4.5, and 3 μc/g, respectively, and the differences in charge amount between LL and HH when the toners of Comparative examples 1 to 6 were used were 1, 1.5, 11, 8, 6, and 15 μc/g, respectively.

### Storage Stability

20 g of each of the toners was put in a plastic container and the container was left in a constant temperature water tank at 55° C. for 8 hours. Then, the toner was sieved through a 42-mesh sieve for 10 seconds using a powder tester manufactured by Hosokawa Micron Corporation by setting the rheostat gauge to 4. The case where the amount of the toner remaining on the sieve was 3 g or less was evaluated as “good”, and the case where the amount exceeds 3 g was evaluated as “poor”.

The obtained results are shown in the following Table 1-2.

As shown in the following Table 1-2, the grades for the storage stability of the toners of Examples 1 to 9 were all “good”. However, the grades for the storage stability of the toners of Comparative examples 1, 2, and 6 were “poor” among the toners of Comparative examples 1 to 6.

### Image Density

200000 sheets of paper was printed under a low-temperature and low-humidity environment, and the case where an image density was 1.35 or more up to the 200000 sheets of paper was evaluated as “good”, and the case where it was less than 1.35 was evaluated as “poor”. The image density was measured using Macbeth RD-19I.

The obtained results are shown in the following Table 1-2.

As shown in the following Table 1-2, the grades for the image density of the toners of Examples 1 to 9 were all “good”. However, the grades for the image density of the toners of Comparative examples 1 and 2 were “poor” among the toners of Comparative examples 1 to 6.

### Fogging

A fogging value was expressed as a reflectance measured by a reflectometer, and the case where a difference in reflectance between printed paper and non-printed paper was 1.5% or less until 200000 sheets of paper were printed was evaluated as “good”, and the case where it exceeded 1.5% was evaluated as “poor”. The reflectance was measured using Photovolt Model 577.

The obtained results are shown in the following Table 1-2.

As shown in the following Table 1-2, the grades for the fogging of the toners of Examples 1 to 9 were all “good”. However, the grade for the fogging of the toner of Comparative example 6 was “poor” among the toners of Comparative examples 1 to 6.

### Filming

In a printing test, the case where filming was not observed until 200000 sheets of paper were printed was evaluated as “good”, the case where filming was not observed until 100000 sheets of paper were printed was evaluated as “moderate”, and the case where filming was observed when less than 100000 sheets of paper were printed was evaluated as “poor”.

The obtained results are shown in the following Table 1-2.

As shown in the following Table 1-2, the grades for the filming of the toners of Examples 1 to 9 were all “good”. However, the grades for the filming of the toners of Comparative examples 1, 2, and 6 were “poor” among the toners of Comparative examples 1 to 6. Volume average particle diameter of toner

The volume average particle diameter of the toner was measured using a coulter counter (manufactured by Beckman Coulter, Inc.).

The obtained results are shown in the above Table 1-1.

As shown in Table 1-1, the volume average particle diameters of the toners of Examples 1 to 9 were 8, 8, 8, 8, 6, 6, 6, 8, and 6, respectively, and the volume average particle diameters of the toners of Comparative examples 1 to 6 were 8, 8, 8, 6, 6, and 6, respectively.

TABLE 1-2

| | Environmental | | | | | |
|---|---|---|---|---|---|---|
| | dependence | | | | | |
| | Difference in | | | | | |
| | charge amount | Storage stability | | | | Comprehensive |
| | (ΔLL-HH) | 55° C. · 8 h | Image density | Fogging | Filming | evaluation |
| Example 1 | 4.4 | good | good | good | good | good |
| Example 2 | 3 | good | good | good | good | good |
| Example 3 | 2.5 | good | good | good | good | good |
| Example 4 | 2 | good | good | good | good | good |
| Example 5 | 4 | good | good | good | good | good |
| Example 6 | 2 | good | good | good | good | good |
| Example 7 | 2.5 | good | good | good | good | good |
| Example 8 | 4.5 | good | good | good | good | good |
| Example 9 | 3 | good | good | good | good | good |
| Comparative | 1 | poor | poor | good | poor | poor |
| example 1 | | | | | | |
| Comparative | 1.5 | poor | poor | good | poor | poor |
| example 2 | | | | | | |
| Comparative | 11 | good | good | good | good | poor |
| example 3 | | | | | | |
| Comparative | 8 | good | good | good | good | poor |
| example 4 | | | | | | |
| Comparative | 6 | good | good | good | good | poor |
| example 5 | | | | | | |
| Comparative | 15 | poor | good | poor | poor | poor |
| example 6 | | | | | | |

From the above results, it is found that the deterioration of the storage property or a harmful effect on image quality can be improved by setting the addition amount of the moisturizing agent to 5 to 20% by weight based on the weight of the toner particles and allowing the coverage factor C calculated from the volume average particle diameter A of the toner particles and the addition amount B of the additive to fall within a range of 10 or more as shown in the following formula (1).

C=A×B≧10 (1)

In the formula (1), A represents the volume average particle diameter of the toner particles (μm), B represents the addition amount of the additive (% by weight), and C represents the coverage factor.

Further, it is found that according to this configuration, the environmental dependence can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent, comprising toner particles having a volume average particle diameter A (μm) and containing a coloring agent, a binder resin, and 5 to 20% by weight of a moisturizing agent based on the weight of the toner particles, and an additive which is added to the surfaces of the toner particles as satisfying the following formula (1):
C=A×B≧10 (1)
when A represents the volume average particle diameter of the toner particles (μm), and B represents the addition amount of the additive (% by weight), C represents a coverage factor the developing agent.

2. The developing agent according to claim 1, wherein the coverage factor C is from 10 to 50.

3. The developing agent according to claim 1, wherein the additive is at least one of silicon oxide and titanium oxide.

4. The developing agent according to claim 1, wherein the additive has a volume average particle diameter of from 8 to 18 nm.

5. The developing agent according to claim 1, wherein the moisturizing agent is at least one material selected from the group consisting of glycerin, propylene glycol, butylene glycol, sorbitol, an amino acid, pyrrolidone carboxylic acid, lactic acid, and urea.
